(19) United States
(12) Patent Application Publication
(10) Pub. No.: US 2025/0326885 A1
(43) Pub. Date: Oct. 23, 2025

(54) SOLUTION OF POLYPHENOLS IN AMINE

(71) Applicant: SIKA TECHNOLOGY AG, Baar (CH)

(72) Inventors: Edis KASEMI, Zürich (CH); Urs BURCKHARDT, Zürich (CH); Ursula STADELMANN, Zürich (CH); Andreas KRAMER, Zürich (CH)

(73) Assignee: SIKA TECHNOLOGY AG, Baar (CH)

(21) Appl. No.: 18/862,818

(22) PCT Filed: Jun. 19, 2023
(86) PCT No.: PCT/EP2023/066476

§ 371 Date: Nov. 4, 2024

(30) Foreign Application Priority Data
Jun. 21, 2022 (EP) 22180238.2

(51) Int. Cl. C08G 59/56; C08G 59/22; C08G 59/24; C08G 59/50; C08G 59/62

(52) U.S. Cl. CPC C08G 59/56; C08G 59/223; C08G 59/245; C08G 59/502; C08G 59/5033; C08G 59/5046; C08G 59/621; C08G 59/628

(57) ABSTRACT

A solution including 5 to 65 wt. % polyphenols which are solid at room temperature and 35 to 95 wt. % amines of formula (I). The solution is preferably used for preparing a curing agent for epoxy resins. The solution has low viscosity and can be readily mixed with, and is compatible with, epoxy resins. The solution allows in particular readily processable, low-emission epoxy resin coatings having rapid curing, high final hardness, a flawless, glossy surface and low levels of yellowing, which also cure in a problem-free manner in cold conditions to form coatings of high quality and robustness without using any, or using only a small amount of, thinners.

### TECHNICAL FIELD

The invention relates to solutions of polyphenols in amines, to the use thereof for production of curing agents for epoxy resins, and to room temperature-curing epoxy resin compositions formed therefrom.

### PRIOR ART

Room temperature-curing polymer compositions based on epoxy resins are widely used in the building trade. They consist of liquid resin components and curing agent components, which are mixed before application and cure at ambient temperatures to form a material of high strength and stability. Under cool ambient conditions, for instance in the temperature range from 15° C. to just above 0° C., however, such systems often cure only slowly and do not develop the desired final hardness even in the case of subsequent heating. Moreover, they have a tendency to surface defects such as haze, spots, roughness or stickiness, which is also referred to as “blushing” and occurs at elevated air humidity in particular. Particularly in coating applications where high surface quality and hardness is crucial, these disadvantages are very undesirable and often lead to laborious reworking. The use of customary accelerators such as 2,4,6-tris(dimethylaminomethyl) phenol can usually only partly solve the problems, if at all.

Other well known accelerators are phenol compounds, especially for rapid curing at low temperatures. But customary liquid phenol compounds such as phenol itself, tert-butylphenol or nonylphenol are substances of high toxicity and have therefore barely been usable in epoxy resin products for some time. Likewise known is cardanol, a phenol substituted by a C₁₅ hydrocarbon chain, which is obtained from the shells of cashew nuts. But the accelerating effect of cardanol is small, it has poor compatibility with epoxy resins in relatively large amounts, and has an unwanted lowering effect on the glass transition temperature of the cured products. Also known as accelerators are polyphenols, especially what are called phenolic resins, especially those from the polymerization of phenol with formaldehyde. But polyphenols are typically solid at room temperature, sparingly soluble, and usually of high viscosity as a solution in customary amine curing agents. Dilution with solvents such as xylene is disadvantageous in that this gives rise to undesirably high emissions.

U.S. Pat. No. 6,649,729 describes the use of phenolic resins in epoxy resin products with customary amine curing agents such as isophoronediamine (IPDA) or diethylenetriamine for acceleration of curing and reduction of blushing. US 2010/0210758 describes the use of large amounts of phenolic resin in epoxy resin coatings with amine curing agents such as 1,3-bis(aminomethyl)benzene (MXDA) or trimethylhexanediamine (TMD) for acceleration of curing and increasing of chemical stability.

Alkylated amines such as N-benzylethane-1,2-diamine are known as curing agents for epoxy resins, for example from WO 2020/070082. Even at low temperatures, they enable epoxy resin coatings having attractive surfaces, although the final hardness thereof after curing under cold conditions tends to be lower than after curing at room temperature.

### SUMMARY OF THE INVENTION

It is an object of the present invention to provide a room temperature liquid accelerator for the curing of epoxy resins that shows high efficacy as accelerator, has low viscosity and good miscibility and compatibility with epoxy resins, and assures faultless and complete curing under cold ambient conditions.

This object is surprisingly achieved by a solution comprising 5% to 65% by weight of room temperature solid polyphenols and 35% to 95% by weight of amines of the formula (I) as described in claim 1. The amine of the formula (I) is surprisingly able to dissolve large amounts of polyphenols while having readily workable viscosity. The solution of the invention is used particularly advantageously for production of a curing agent for epoxy resins. The solution of the invention can be used to produce, in a simple manner, curing agents having a readily adjustable polyphenol content, which are miscible and compatible with particularly low viscosity and in an excellent manner with epoxy resins. A particularly surprising fact is that these curing agents enable epoxy resin products with particularly faultless curing under cold conditions and particularly high final hardnesses. In particular, they enable epoxy resin coatings having surprisingly high hardness after curing under cold conditions (8° C./80% relative humidity) for 7 days followed by curing under standard climatic conditions for 14 days, said hardness being very close to the hardness obtained after curing under standard climatic conditions for 14 days. Preferably, the hardness measured as Konig's hardness is at least 70%, more preferably at least 80%, especially at least 90%, of the value after curing under standard climatic conditions. This curing under cold conditions is achieved even with a surprisingly small amount of the solution of the invention, which means that processibility of such coatings is very good even without or with a small amount of thinner, and these thus have a particularly low level of emissions.

The amines that are customary in the prior art as curing agents for epoxy resins, for example IPDA or MXDA, are much less suitable for production of a polyphenol solution. With certain polyphenols, for example diphenolic acid, very high-viscosity to pasty solutions and/or solutions incompatible with epoxy resins, are thus obtained. With other polyphenols such as phenol-formaldehyde novolaks in particular, although solutions of similarly low viscosity and compatibility are in part obtained and these enable accelerated curing of epoxy resins, coatings cured therewith show greatly reduced final hardness in the case of curing under cold conditions, which restricts the robustness of the coating or necessitates laborious reworking.

The solution of the invention enables readily processible, low-emission epoxy resin coatings having rapid curing, high final hardness, a faultless glossy surface and low yellowing, which cure in a surprisingly faultless manner under cold conditions, especially at temperatures of 5 to 8° C., to give coatings of high quality and robustness even without or with only a small amount of thinners such as benzyl alcohol.

Further aspects of the invention are the subject of further independent claims. Particularly preferred embodiments of the invention are the subject of the dependent claims.

### Ways of Executing the Invention

The invention provides a solution comprising 5% to 65% by weight of room temperature solid polyphenols and 35% to 95% by weight of amines of the formula (I)

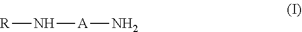

where
A is a linear or branched alkylene radical having 2 to 10 carbon atoms and
R is a monovalent hydrocarbon radical optionally containing an oxygen atom and having 1 to 12 carbon atoms,
where the amine of the formula (I) has a total of 8 to 15 carbon atoms and the two nitrogen atoms are separated from one another by at least two carbon atoms.

“Solution” refers to a clear homogeneous liquid having constituents fully dissolved therein.

“Polyphenol” refers to a compound having two or more phenol groups (=phenolic OH groups). “Phenolic resin” refers to a polymer having repeat units containing phenol groups. “Amine hydrogen” refers to the hydrogen atoms of primary and secondary amino groups.

“Amine hydrogen equivalent weight” refers to the mass of an amine or an amine-containing composition that contains one molar equivalent of amine hydrogen. It is expressed in units of “g/eq”.

“Epoxy equivalent weight” refers to the mass of an epoxy group-containing compound or composition that contains one molar equivalent of epoxy groups. It is expressed in units of “g/eq”.

Substance names beginning with “poly”, such as polyamine or polyepoxide, refer to substances that formally contain two or more of the functional groups that occur in their name per molecule.

A “primary amino group” refers to an amino group which is bonded to a single organic radical and bears two hydrogen atoms; a “secondary amino group” refers to an amino group which is bonded to two organic radicals that may also together be part of a ring and bears one hydrogen atom; and a “tertiary amino group” refers to an amino group which is bonded to three organic radicals, two or three of which may also be part of one or more rings, and does not bear any hydrogen atom.

A “thinner” refers to a substance that is soluble in an epoxy resin and lowers its viscosity, and that is not chemically incorporated into the epoxy resin polymer during the curing process.

“Molecular weight” refers to the molar mass (in grams per mole) of a molecule.

“Average molecular weight” refers to the number-average Mₙ of a polydisperse mixture of oligomeric or polymeric molecules, which is typically determined by gel-permeation chromatography (GPC) against polystyrene as standard.

A dotted line in the formulae in this document in each case represents the bond between a substituent and the corresponding remainder of the molecule.

“Pot life” refers to the maximum period of time from the mixing of the components and the application of an epoxy resin composition in which the mixed composition is in a sufficiently free-flowing state and has good ability to wet the substrate surfaces.

“Room temperature” refers to a temperature of 23° C.

All industry standards and norms mentioned in the document refer to the versions valid at the date of first filing, unless otherwise stated.

Percentages by weight (% by weight) refer to the proportions by mass of a constituent in a composition based on the overall composition, unless otherwise stated. The terms “mass” and “weight” are used synonymously in the present document.

Preference is given to polyphenols having a melting or softening point of at least 50° C.

Preferred polyphenols are room temperature solid compounds having 2 to 10 phenol groups, and room temperature solid polymers containing phenol groups, which especially contain an average of 3 to 100, preferably 3 to 50, phenol groups.

Suitable room temperature solid compounds having 2 to 10 phenol groups are especially catechol (1,2-dihydroxyphenol), resorcinol (1,3-dihydroxyphenol), hydroquinone (1,4-dihydroxyphenol), the isomeric dihydroxybenzoic acids, gallic acid (3,4,5-trihydroxybenzoic acid), bisphenol A (2,2-bis(4-hydroxyphenyl) propane), bisphenol F (bis(4-hydroxyphenyl) methane), bisphenol E (1,1-bis(4-hydroxyphenyl) ethane), bisphenol B (2,2-bis(4-hydroxyphenyl) butane), bisphenol Z (1,1-bis(4-hydroxyphenyl)cyclohexane), diphenolic acid (4,4-bis(4-hydroxyphenyl) valeric acid), and degradation products of lignin such as, in particular, resveratrol (3,5,4′-trihydroxystilbene), malvidin (3,4′,5,7-tetrahydroxy-3′,5′-dimethoxyflavylium) or catechin (2-(3,4-dihydroxyphenyl) chromane-3,5,7-triol).

It is preferable that the room temperature solid polyphenol is selected from the group consisting of gallic acid, diphenolic acid, resveratrol, catechin and polymers containing phenol groups, especially phenolic resins.

Particular preference is given to diphenolic acid. This polyphenol is obtainable in a simple method from renewable raw materials, is soluble in a large amount in the amine of the formula (I) and enables readily processible epoxy resin coatings having rapid curing, high final hardness and attractive surfaces.

Also particularly preferred as polyphenols are room temperature solid polymers containing phenol groups, especially what are called phenolic resins.

The phenolic resin preferably contains repeat units from the polymerization of phenol, cresol, xylenol and/or cardanol with an aldehyde, especially formaldehyde. Preference is given to room temperature solid phenolic resins derived from phenol (hydroxybenzene), n-cresol or cardanol, especially phenol.

In particular, the room temperature solid polyphenol is a phenol-formaldehyde novolak or a cardanol-containing phenol-formaldehyde novolak, more preferably a phenol-formaldehyde novolak.

The room temperature solid polyphenol is preferably a phenolic resin of the formula (II)

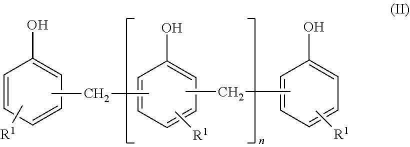

where
n has an average value of 1 to 45, preferably 1 to 25, especially 1 to 10, and
R¹ is independently H or an aliphatic hydrocarbon radical having 1 to 15 carbon atoms, preferably H, methyl or a linear aliphatic C₁₅ hydrocarbon radical having zero, one, two or three double bonds.

A phenolic resin of the formula (II) is especially obtained from the polymerization of at least one phenol compound of the formula

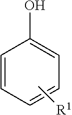

with formaldehyde, with release of water. Preference is given to using formaldehyde in the form of paraformaldehyde. Preference is given to removing the volatile constituents after the polymerization to such an extent that the content of free phenol (R¹=H) in the phenolic resin is less than 1% by weight, and the content of formaldehyde is less than 0.1% by weight.

Preferably, the —CH₂— units in formula (II) are in the ortho or para position to the phenol group.

Preferably, an R¹ that is not H is in the meta position to the phenol group.

If R¹ is a linear aliphatic C₁₅ hydrocarbon radical having zero, one, two or three double bonds, this radical is preferably derived from cardanol.

“Cardanol” refers to an alkenylphenol mixture of the formula

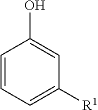

that has been obtained from the oil of the cashew nut shell in which R¹ is a linear aliphatic C₁₅H₃₁ or C₁₅H₂₉ or C₁₅H₂₇ or C₁₅H₂₅ hydrocarbon radical, especially the radicals of the formulae

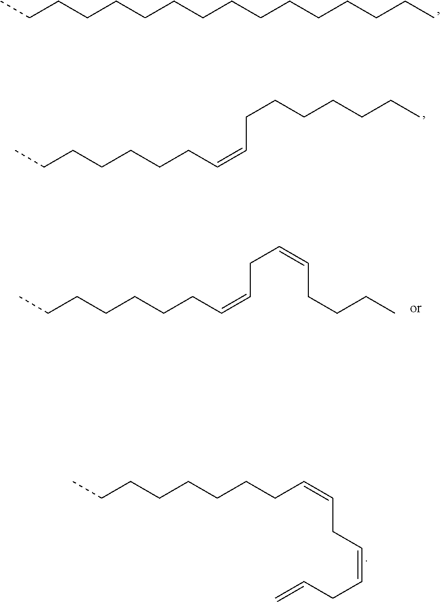

Preferably, in formula (II), all R¹ radicals are H, or at least half the R¹ radicals are H and the other R¹ radicals are derived from cardanol.

Most preferred are phenolic resins in which all the R¹ radicals are H. Such a phenolic resin is also referred to as a phenol-formaldehyde novolak.

Preference is given to phenolic resins of the formula (II) having an average molecular weight Mₙ of 300 to 5,000 g/mol, preferably 350 to 3,000 g/mol, especially 400 to 1,500 g/mol.

Preference is given to phenolic resins of the formula (II) having a softening temperature of 55 to 140° C., especially 60 to 120° C.

The preferred polyphenols can be dissolved in a particularly large amount in the amine of the formula (I), and the solutions thus obtained enable epoxy resin coatings having particularly faultless curing under cold conditions.

The solution of the invention further comprises at least one amine of the formula (I)

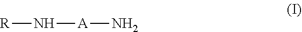

where
A is a linear or branched alkylene radical having 2 to 10 carbon atoms and
R is a monovalent hydrocarbon radical optionally containing an oxygen atom and having 1 to 12 carbon atoms,
where the amine of the formula (I) has a total of 8 to 15 carbon atoms and the two nitrogen atoms are separated from one another by at least two carbon atoms.

Preferably, A is selected from the group consisting of 1,2-ethylene, 1,2-propylene, 1,3-propylene, 1,4-butylene, 1,3-butylene, 2-methyl-1,2-propylene, 1,3-pentylene, 1,5-pentylene, 2,2-dimethyl-1,3-propylene, 1,6-hexylene, 2-methyl-1,5-pentylene, 1,7-heptylene, 1,8-octylene, 2,5-dimethyl-1,6-hexylene, 1,9-nonylene and 1,10-decylene.

Among these, preference is given to 1,2-ethylene, 1,2-propylene, 1,3-propylene, 1,4-butylene, 1,5-pentylene, 1,6-hexylene, especially 1,2-ethylene or 1,2-propylene.

Most preferred is 1,2-ethylene.

Preferably, R contains at least one aromatic or aliphatic ring, especially at least one aromatic ring.

In particular, R is selected from the group consisting of benzyl, furfuryl, 2-phenylethyl, cyclohexylmethyl and tetrahydrofurfuryl.

Among these, preference is given to benzyl or furfuryl, especially benzyl.

A particularly preferred amine of the formula (I) is N-benzylethane-1,2-diamine, N-benzylpropane-1,2-diamine, N-furfurylethane-1,2-diamine, N-tetrahydrofurfurylethane-1,2-diamine, especially N-benzylethane-1,2-diamine, N-furfurylethane-1,2-diamine or N-tetrahydrofurfurylethane-1,2-diamine.

The most preferred amine of the formula (I) is N-benzylethane-1,2-diamine.

It is possible to dissolve particularly large amounts of polyphenol in the preferred amines of the formula (I), and the resulting solutions enable epoxy resin coatings with particularly faultless curing under cold conditions.

The solution of the invention preferably comprises 10% to 50% by weight, especially 20% to 45% by weight, of polyphenols. Such a solution has readily workable viscosity and good miscibility or compatibility with epoxy resins.

The solution of the invention preferably comprises 50% to 90% by weight, especially 55% to 80% by weight, of amines of the formula (I). Such a solution has readily workable viscosity and a high content of phenol groups.

Preferably, the weight ratio between polyphenols and amines of the formula (I) in the solution of the invention is in the range from 5/95 to 65/35, more preferably 10/90 to 50/50, especially 20/80 to 45/55.

The solution of the invention may contain further constituents.

A preferred solution contains
5% to 65% by weight, preferably 10% to 50% by weight, especially 20% to 45% by weight, of room temperature solid polyphenols,
35% to 95% by weight, especially 50% to 90% by weight, of amines of the formula (I), and
0% to 30% by weight of further amines that do not conform to the formula (I) and/or thinners and/or accelerators.

In a preferred embodiment, the solution contains, as a further constituent, at least one amine of the formula (Ia) and/or one amine of the formula (Ib)

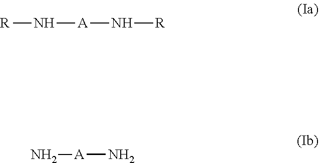

where A and R have the definitions given above and are each the same radical as in the corresponding amine of the formula (I),
   and/or amine-functional adducts of the amine of the formula (I) with at least one mono- or polyepoxide.

The amine of the formula (Ia) corresponds to the N,N′-dialkylated amine of the corresponding monoalkylated amine of the formula (I), and the amine of the formula (Ib) corresponds to the corresponding nonalkylated amine. Such an amine mixture is especially the reaction product of a reductive alkylation of the amine of the formula (Ib) with a substoichiometric amount of an aldehyde or ketone, especially benzaldehyde or furfural, and hydrogen.

Preferably, the unconverted amine of the formula (Ib) is largely removed from the reaction mixture after the alkylation, especially by distillation, to afford an amine mixture containing the amine of the formula (I) and the corresponding amine of the formula (Ia).

In a preferred embodiment of the invention, the amine of the formula (I) is used in a purity of >95% for dissolution of the polyphenol. The solution of the invention is then largely free of amines of the formulae (Ia) and (Ib).

In a further preferred embodiment of the invention, the amine of the formula (I) is used as a mixture with the corresponding amines of the formulae (Ia) and (Ib), where the weight ratio between the amine of the formula (I) and the amine of the formula (Ia) is preferably in the range from 70/30 to 90/10, and the content of amine of the formula (Ib) is preferably less than 1% by weight, based on the sum total of amine of the formulae (I) and (Ia). Such an amine mixture is producible particularly inexpensively and is just as suitable for dissolution of the polyphenol as a more highly purified amine of the formula (I).

The solution of the invention may also contain amine-functional adducts of the amine of the formula (I) with at least one mono- or polyepoxide. A suitable monoepoxide is especially cresyl glycidyl ether. Preference is given to adducts with at least one polyepoxide, especially a bisphenol A diglycidyl ether or bisphenol F diglycidyl ether or a phenol novolak glycidyl ether having an average functionality of 2.3 to 4. Most preferred are amine-functional adducts of the amine of the formula (I) with a bisphenol A diglycidyl ether.

Further constituents that may contain the solution of the invention are especially
accelerators such as, in particular, 3-(3-dimethylaminopropylamino) propylamine (DMAPAPA), 2,4,6-tris(dimethylaminomethyl) phenol, salicylic acid, calcium nitrate and/or water, or
thinners such as, in particular, benzyl alcohol, styrenated phenol, ethoxylated phenol, room temperature liquid aromatic hydrocarbon resins containing phenol groups, such as, in particular, the Novares® LS 500, LX 200, LA 300 or LA 700 grades (from Rütgers), diisopropylnaphthalene, diisopropylbiphenyl, isopropylbiphenyl or cardanol, especially benzyl alcohol.

The solution of the invention preferably contains a content of free phenol (hydroxybenzene) of less than 0.5% by weight, preferably less than 0.2% by weight, especially less than 0.1% by weight, based on the overall solution. Such a solution is particularly advantageous in toxicological terms.

The solution of the invention preferably has a viscosity at 20° C. in the range from 0.01 to 100 Pa·s, more preferably 0.02 to 50 Pa·s, especially preferably 0.03 to 20 Pa·s, in particular 0.05 to 10 Pa·s.

The solution of the invention is particularly suitable for production of a curing agent for epoxy resins. With the solution of the invention, it is possible to produce the curing agent in a rapid and simple manner and to adjust the polyphenol content efficiently. The curing agents obtained with the solution have excellent miscibility and compatibility with epoxy resins and enable efficiently processible, low-emission epoxy resin coatings having rapid curing, high final hardness, a faultless shiny surface, low yellowing and particularly faultless curing under cold conditions.

The invention thus further provides for the use of the solution described for production of a curing agent for epoxy resins, wherein the curing agent contains at least one further amine having at least three amine hydrogens.

Preferably, the further amine having at least three amine hydrogens is selected from the group consisting of amines of the formula (I), 1,5-diamino-2-methylpentane (MPMD), 2-butyl-2-ethylpentane-1,5-diamine (C11 neodiamine), 2,2 (4),4-trimethylhexane-1,6-diamine (TMD), 1,2-diaminocyclohexane, 1,3-bis(aminomethyl)cyclohexane, 1,4-bis(aminomethyl)cyclohexane, bis(4-aminocyclohexyl) methane, isophoronediamine (IPDA), 2 (4)-methyl-1,3-diaminocyclohexane, 2,5 (2,6)-bis(aminomethyl) bicyclo[2.2.1]heptane (NBDA), 1,3-bis(aminomethyl)benzene (MXDA), diethylenetriamine (DETA), triethylenetetramine (TETA), tetraethylenepentamine (TEPA), dipropylenetriamine (DPTA), N-(2-aminoethyl) propane-1,3-diamine (N3 amine), N,N′-bis(3-aminopropyl)ethylenediamine (N4 amine), bis(hexamethylene)triamine (BHMT), polyoxypropylenediamines having an average molecular weight Mₙ in the range from 200 to 500 g/mol, polyoxypropylenetriamines having an average molecular weight Mₙ in the range from 300 to 500 g/mol, 3-(3-(dimethylamino) propylamino) propylamine (DMAPAPA), 2,5-bis(aminomethyl) furan, 2,5-bis(aminomethyl)tetrahydrofuran, bis(5-aminomethylfuran-2-yl) methane, bis(5-aminomethyltetrahydrofuran-2-yl) methane, 2,2-bis(5-aminomethylfuran-2-yl) propane, 2,2-bis(5-aminomethyltetrahydrofuran-2-yl) propane, amine-functional adducts of the amines mentioned with mono- or polyepoxides, phenalkamines and mixtures of two or more of the amines mentioned.

Preferred mono- or polyepoxides for amine-functional adducts are cresyl glycidyl ether and especially bisphenol A diglycidyl ether or phenol novolak glycidyl ether having an average functionality of 2.3 to 4. Preference is given to amine-functional adducts with bisphenol A diglycidyl ether.

Preferred phenalkamines are reaction products of cardanol with formaldehyde and amines such as, in particular, DETA, TETA or MXDA.

Particularly preferred further amines having at least three amine hydrogens are amines of the formula (I), especially N-benzylethane-1,2-diamine, N-furfurylethane-1,2-diamine or N-tetrahydrofurfurylethane-1,2-diamine, and also IPDA, MXDA, 1,3-bis(aminomethyl)cyclohexane, TETA, TEPA, N4 amine, DMAPAPA or adducts of these amines with bisphenol A diglycidyl ether.

The curing agent preferably contains further constituents, especially accelerators and/or thinners.

Suitable accelerators are especially acids or compounds hydrolyzable to acids, especially organic carboxylic acids such as acetic acid, benzoic acid, salicylic acid, 2-nitrobenzoic acid, lactic acid, organic sulfonic acids such as methanesulfonic acid, p-toluenesulfonic acid or 4-dodecylbenzenesulfonic acid, sulfonic esters, other organic or inorganic acids, such as phosphoric acid in particular, or mixtures of the aforementioned acids and acid esters; nitrates such as calcium nitrate in particular; tertiary amines such as, in particular, 1,4-diazabicyclo[2.2.2]octane, benzyldimethylamine, α-methylbenzyldimethylamine, triethanolamine, dimethylaminopropylamine, imidazoles such as, in particular, N-methylimidazole, N-vinylimidazole or 1,2-dimethylimidazole, salts of such tertiary amines, quaternary ammonium salts, such as benzyltrimethylammonium chloride in particular, amidines, such as 1,8-diazabicyclo[5.4.0]undec-7-ene in particular, guanidines, such as 1,1,3,3-tetramethylguanidine in particular, compounds containing phenol groups, especially Mannich bases such as, in particular, 2-(dimethylaminomethyl) phenol or 2,4,6-tris(dimethylaminomethyl) phenol, phosphites such as, in particular, di- or triphenyl phosphites, or compounds having mercapto groups.

Preference is given to acids, nitrates, tertiary amines or Mannich bases, especially salicylic acid, calcium nitrate or 2,4,6-tris(dimethylaminomethyl) phenol, or a combination of these accelerators.

Suitable thinners are especially n-propanol, isopropanol, n-butanol, isobutanol, tert-butanol, 1-pentanol, 2-pentanol, 3-pentanol, 2-methyl-1-butanol, 3-methyl-1-butanol, 3-methyl-2-butanol, n-hexanol, 2-ethylhexanol, xylene, 2-methoxyethanol, dimethoxyethanol, 2-ethoxyethanol, 2-propoxyethanol, 2-isopropoxyethanol, 2-butoxyethanol, 2-phenoxyethanol, 2-benzyloxyethanol, benzyl alcohol, ethylene glycol, ethylene glycol dimethyl ether, ethylene glycol diethyl ether, ethylene glycol dibutyl ether, ethylene glycol diphenyl ether, diethylene glycol, diethylene glycol monomethyl ether, diethylene glycol monoethyl ether, diethylene glycol mono-n-butyl ether, diethylene glycol dimethyl ether, diethylene glycol diethyl ether, diethylene glycol di-n-butyl ether, propylene glycol butyl ether, propylene glycol phenyl ether, dipropylene glycol, dipropylene glycol monomethyl ether, dipropylene glycol dimethyl ether, dipropylene glycol di-n-butyl ether, 2,2,4-trimethylpentane-1,3-diol monoisobutyrate, diphenylmethane, diisopropylnaphthalene, diisopropylbiphenyl, isopropylbiphenyl, mineral oil fractions, for example Solvesso® grades (Exxon), alkylphenols such as tert-butylphenol, nonylphenol, dodecylphenol, cardanol, styrenated phenol, bisphenols, aromatic hydrocarbon resins, especially types containing phenol groups, alkoxylated phenol, especially ethoxylated or propoxylated phenol, especially 2-phenoxyethanol, adipates, sebacates, phthalates, benzoates, organic phosphoric or sulfonic esters or sulfonamides.

Preference among these is given to thinners having a boiling point of more than 200° C., especially benzyl alcohol, styrenated phenol, ethoxylated phenol, aromatic hydrocarbon resins containing phenol groups, such as, in particular, the Novares® grades LS 500, LX 200, LA 300 or LA 700 (from Rütgers), diisopropylnaphthalene, diisopropylbiphenyl, isopropylbiphenyl or cardanol, especially benzyl alcohol.

The curing agent preferably contains only a small content of thinners, in particular 0% to 30% by weight, more preferably 0% to 20% by weight, of thinners based on the overall curing agent. This enables particularly low-emission epoxy resin products.

The curing agent may be water-based and contain water in the range from 15% to 90% by weight, preferably 20% to 80% by weight.

The curing agent is preferably not water-based. It preferably contains less than 15% by weight, especially less than 10% by weight, of water, based on the overall curing agent. Such a curing agent is particularly suitable for nonaqueous epoxy resin products.

The curing agent may contain further constituents, especially:
additional amines of the formula (I),
further adducts, especially adducts of MPMD or ethane-1,2-diamine or propane-1,2-diamine with cresyl glycidyl ether or aromatic epoxy resins, in which unconverted MPMD, ethane-1,2-diamine or propane-1,2-diamine has been removed by distillation after the reaction,
monoamines such as, in particular, benzylamine or furfurylamine,
polyamidoamines, especially reaction products of a mono- or polybasic carboxylic acid, or the ester or anhydride thereof, especially a dimer fatty acid, with a polyamine used in stoichiometric excess, especially DETA or TETA,
Mannich bases,
aromatic polyamines such as, in particular, 4,4′-, 2,4′ and/or 2,2′-diaminodiphenylmethane, toluene-2,4 (6)-diamine, 3,5-dimethylthiotoluene-2,4 (6)-diamine or 3,5-diethyltolylene-2,4 (6)-diamine,
compounds having mercapto groups, especially liquid mercaptan-terminated polysulfide polymers, mercaptan-terminated polyoxyalkylene ethers, mercaptan-terminated polyoxyalkylene derivatives, polyesters of thiocarboxylic acids, 2,4,6-trimercapto-1,3,5-triazine, triethylene glycol dimercaptan or ethanedithiol,
surface-active additives, especially defoamers, deaerating agents, wetting agents, dispersants or leveling agents, or
stabilizers, especially stabilizers against oxidation, heat, light or UV radiation.

Preferably, the curing agent contains 2% to 30% by weight, preferably 5% to 25% by weight, of room temperature solid polyphenols based on the sum total of all liquid or dissolved constituents present in the curing agent. Such a curing agent enables readily processible epoxy resin coatings having particularly faultless curing under cold conditions. If the curing agent contains pigments, carbon black or mineral fillers, these are thus not included for the calculation of the polyphenol content.

Preferably, the curing agent, based on the sum total of all liquid or dissolved constituents present in the curing agent, has an amine hydrogen equivalent weight of 50 to 140 g/eq, preferably 55 to 120 g/eq, more preferably 60 to 100 g/eq, especially 65 to 90 g/eq. Such a curing agent enables low-emission epoxy resin coatings having high final hardness and particularly attractive surfaces, especially after curing under cold conditions.

The curing agent is preferably of low viscosity. In particular, the viscosity of the curing agent at 20° C., based on the sum total of all liquid or dissolved constituents present in the curing agent, is in the range from 10 to 5,000 mPa·s, preferably 10 to 1,000 mPa·s, more preferably 10 to 500 mPa·s, especially 10 to 250 mPa·s, measured by cone-plate viscometer.

The curing agent containing the solution of the invention is especially used for curing of at least one epoxy resin. The solution may first be mixed with the further ingredients and may optionally even be stored as such. Or the solution can be added as a separate component only when the curing agent is used for curing of the epoxy resin.

The invention thus further provides an epoxy resin composition comprising a resin component containing at least one epoxy resin and either
a curing agent component comprising the curing agent containing the solution of the invention and at least one further amine having at least three amine hydrogens, as described above,
or
a curing agent component comprising at least one amine having at least three amine hydrogens and, as a separate, third component, the solution of the invention.

A suitable epoxy resin is obtained in a known manner, especially from the reaction of epichlorohydrin with polyols, polyphenols or amines.

Suitable epoxy resins are especially aromatic epoxy resins, especially the glycidyl ethers of:
bisphenol A, bisphenol F or bisphenol A/F, where A stands for acetone and F for formaldehyde used as reactants in the production of these bisphenols. In the case of bisphenol F, positional isomers may also be present, more particularly ones derived from 2,4′- or 2,2′-hydroxyphenylmethane.
dihydroxybenzene derivatives such as resorcinol, hydroquinone or catechol;
further bisphenols or polyphenols such as bis(4-hydroxy-3-methylphenyl) methane, 2,2-bis(4-hydroxy-3-methylphenyl) propane (bisphenol C), bis(3,5-dimethyl-4-hydroxyphenyl) methane, 2,2-bis(3,5-dimethyl-4-hydroxyphenyl) propane, 2,2-bis(3,5-dibromo-4-hydroxyphenyl) propane, 2,2-bis(4-hydroxy-3-tert-butylphenyl) propane, 2,2-bis(4-hydroxyphenyl) butane (bisphenol B), 3,3-bis(4-hydroxyphenyl) pentane, 3,4-bis(4-hydroxyphenyl) hexane, 4,4-bis(4-hydroxyphenyl) heptane, 2,4-bis(4-hydroxyphenyl)-2-methylbutane, 2,4-bis(3,5-dimethyl-4-hydroxyphenyl)-2-methylbutane, 1,1-bis(4-hydroxyphenyl)cyclohexane (bisphenol Z), 1,1-bis(4-hydroxyphenyl)-3,3,5-trimethylcyclohexane (bisphenol TMC), 1,1-bis(4-hydroxyphenyl)-1-phenylethane, 1,4-bis[2-(4-hydroxyphenyl)-2-propyl]benzene (bisphenol P), 1,3-bis[2-(4-hydroxyphenyl)-2-propyl]benzene (bisphenol M), 4,4′-dihydroxydiphenyl (DOD), 4,4′-dihydroxybenzophenone, bis(2-hydroxynaphth-1-yl) methane, bis(4-hydroxynaphth-1-yl) methane, 1,5-dihydroxynaphthalene, tris(4-hydroxyphenyl) methane, 1,1,2,2-tetrakis(4-hydroxyphenyl) ethane, bis(4-hydroxyphenyl) ether or bis(4-hydroxyphenyl) sulfone;
novolaks, which are especially condensation products of phenol or cresols with formaldehyde or paraformaldehyde or acetaldehyde or crotonaldehyde or isobutyraldehyde or 2-ethylhexanal or benzaldehyde or furfural;
aromatic amines such as aniline, toluidine, 4-aminophenol, 4,4′-methylenediphenyldiamine, 4,4′-methylenediphenyldi (N-methyl)amine, 4,4′-[1,4-phenylenebis(1-methylethylidene)]bisaniline (bisaniline P) or 4,4′-[1,3-phenylenebis(1-methylethylidene)]bisaniline (bisaniline M).

Further suitable epoxy resins are aliphatic or cycloaliphatic polyepoxides, especially
glycidyl ethers of saturated or unsaturated, branched or unbranched, cyclic or open-chain di-, tri- or tetrafunctional C₂ to C₃₀ alcohols, especially ethylene glycol, propylene glycol, butylene glycol, hexanediol, octanediol, polypropylene glycols, dimethylolcyclohexane, neopentyl glycol, dibromoneopentyl glycol, castor oil, trimethylolpropane, trimethylolethane, pentaerythritol, sorbitol or glycerol, or alkoxylated glycerol or alkoxylated trimethylolpropane;
a hydrogenated bisphenol A, F or A/F liquid resin or the glycidylation products of hydrogenated bisphenol A, F or A/F;
an N-glycidyl derivative of amides or heterocyclic nitrogen bases, such as triglycidyl cyanurate or triglycidyl isocyanurate, or reaction products of epichlorohydrin with hydantoin.

The epoxy resin is preferably a liquid resin or a mixture comprising two or more liquid epoxy resins.

“Liquid epoxy resin” refers to an industrial polyepoxide having a glass transition temperature below 25° C.

The resin component optionally additionally contains proportions of solid epoxy resin.

The epoxy resin is especially a liquid resin based on a bisphenol or novolak, especially having an average epoxy equivalent weight in the range from 156 to 210 g/eq.

A bisphenol A diglycidyl ether and/or bisphenol F diglycidyl ether, such as those commercially available from Olin, Huntsman or Momentive, is particularly suitable. These liquid resins have a low viscosity for epoxy resins and provide for rapid curing and high hardnesses. They may contain proportions of solid bisphenol A resin or novolak epoxy resins.

Also particularly suitable are phenol-formaldehyde novolak glycidyl ethers having an average functionality of 2.3 to 4, preferably 2.5 to 3. These may contain proportions of other epoxy resins, in particular bisphenol A diglycidyl ether or bisphenol F diglycidyl ether.

The resin component may comprise a reactive thinner.

Preferred reactive diluents are reactive thinners containing epoxy groups, especially butanediol diglycidyl ether, hexanediol diglycidyl ether, trimethylolpropane di- or triglycidyl ether, phenyl glycidyl ether, cresyl glycidyl ether, guaiacol glycidyl ether, 4-methoxyphenyl glycidyl ether, p-n-butylphenyl glycidyl ether, p-tert-butylphenyl glycidyl ether, 4-nonylphenyl glycidyl ether, 4-dodecylphenyl glycidyl ether, cardanol glycidyl ether, benzyl glycidyl ether, allyl glycidyl ether, butyl glycidyl ether, hexyl glycidyl ether, 2-ethylhexyl glycidyl ether, or glycidyl ethers of natural alcohols, such as, in particular, C₈- to C₁₀- or C₁₂- to C₁₄- or C₁₃- to C₁₅-alkyl glycidyl ethers.

In one embodiment, the curing agent component comprises the above-described curing agent containing the solution of the invention.

In a further embodiment, the curing agent component comprises at least one amine having at least three amine hydrogens, and the solution of the invention takes the form of a separate, third component.

The epoxy resin composition preferably contains at least one further constituent selected from the group consisting of thinners, accelerators, fillers, pigments, and surface-active additives.

Suitable thinners or accelerators especially include those already mentioned.

Suitable fillers are, in particular, ground or precipitated calcium carbonate, which is optionally coated with fatty acid, especially stearates, baryte (heavy spar), talc, quartz powder, quartz sand, silicon carbide, iron mica, dolomite, wollastonite, kaolin, mica (potassium aluminum silicate), molecular sieves, aluminum oxide, zinc oxide, aluminum-doped zinc oxide, aluminum hydroxide, magnesium hydroxide, silica, cement, gypsum, fly ash, carbon black, graphite, metal powders such as aluminum, copper, iron, zinc, silver or steel, PVC powder or hollow beads. Preference among these is given to calcium carbonate, baryte, quartz powder, talc, aluminum powder or a combination thereof.

Suitable pigments especially include titanium dioxides, iron oxides, chromium (III) oxides, organic pigments, carbon black or anticorrosion pigments, especially phosphates, orthophosphates or polyphosphates containing especially chromium, zinc, aluminum, calcium, strontium or a combination of these metals as counterions. Titanium dioxides are particularly suitable.

Suitable surface-active additives are especially defoamers, deaerating agents, wetting agents, dispersants, leveling agents and/or dispersed paraffin waxes.

The epoxy resin composition optionally contains further auxiliaries and additives, especially
reactive thinners, especially those already mentioned above, or epoxidized soybean oil or linseed oil, compounds containing acetoacetate groups, especially acetoacetylated polyols, butyrolactone, carbonates, aldehydes, isocyanates or silicones having reactive groups,
polymers, especially polyamides, polysulfides, polyvinyl formal (PVF), polyvinyl butyral (PVB), polyurethanes (PUR), polymers having carboxyl groups, polyamides, butadiene-acrylonitrile copolymers, styrene-acrylonitrile copolymers, butadiene-styrene copolymers, homo- or copolymers of unsaturated monomers, especially from the group comprising ethylene, propylene, butylene, isobutylene, isoprene, vinyl acetate or alkyl (meth) acrylates, especially chlorosulfonated polyethylenes or fluorine-containing polymers or sulfonamide-modified melamines,
fibers, especially glass fibers, carbon fibers, metal fibers, ceramic fibers or polymer fibers such as polyamide fibers or polyethylene fibers,
nanofillers, especially carbon nanotubes,
rheology modifiers, especially thickeners or antisettling agents,
adhesion improvers, especially organoalkoxysilanes,
flame-retardant substances, especially the aluminum hydroxide or magnesium hydroxide fillers already mentioned, antimony trioxide, antimony pentoxide, boric acid, zinc borate, zinc phosphate, melamine borate, melamine cyanurate, ammonium polyphosphate, melamine phosphate, melamine pyrophosphate, polybrominated diphenyl oxides or diphenyl ethers, phosphates such as, in particular, diphenyl cresyl phosphate, resorcinol bis(diphenyl phosphate), resorcinol diphosphate oligomer, tetraphenylresorcinol diphosphite, ethylenediamine diphosphate, bisphenol A bis(diphenyl phosphate), tris(chloroethyl) phosphate, tris(chloropropyl) phosphate, tris(dichloroisopropyl) phosphate, tris[3-bromo-2,2-bis(bromomethyl) propyl] phosphate, tetrabromobisphenol A, bis(2,3-dibromopropyl ether) of bisphenol A, brominated epoxy resins, ethylenebis(tetrabromophthalimide), ethylenebis(dibromonorbornanedicarboximide), 1,2-bis(tribromophenoxy) ethane, tris(2,3-dibromopropyl) isocyanurate, tribromophenol, hexabromocyclododecane, bis(hexachlorocyclopentadieno)cyclooctane or chloroparaffins, or
stabilizers against oxidation, heat, light or UV radiation or biocides;

The epoxy resin composition preferably contains only a low content of thinners. It preferably contains less than 20% by weight, particularly preferably less than 10% by weight, in particular less than 5% by weight, most preferably less than 1% by weight, of thinner. Such epoxy resin products have particularly low emissions.

The epoxy resin composition may contain water.

In one embodiment the epoxy resin composition is water-based. The epoxy resin is preferably emulsified in water in an amount of 50% to 85% by weight, and the curing agent component preferably contains 20% to 80% by weight of water. The epoxy resin composition preferably has only a low content of water, preferably less than 5% by weight, especially less than 1% by weight, of water. Such a non-water-based epoxy resin composition is particularly versatile and particularly water-resistant.

The resin component, the curing agent component and—if present—the third component or the solution of the invention are stored in separate containers. A suitable container is especially a drum, a hobbock, a bag, a bucket, a can, a cartridge or a tube. The components are storable, meaning that they can be stored prior to use for several months up to one year or longer without any change in their respective properties to a degree relevant to their use.

If the solution of the invention takes the form of a constituent of the curing agent component, the resin component and the curing agent component are mixed with one another shortly before or during application.

If the solution of the invention takes the form of a separate, third component, the three components are mixed with one another shortly before or during application.

Any sequence is possible here. Preference is given to mixing all three components together, or to mixing the curing agent component and the third component first and then mixing the mixture with the resin component. Also possible, but less preferred, is an operation in which the resin component and the curing agent component are mixed first, and then the third component is mixed in.

The mixing ratio of the components is preferably chosen such that the molar ratio of epoxy-reactive groups to epoxy groups is in the range from 0.5 to 1.5, especially 0.7 to 1.2, and such that the polyphenol content in the curing agent is within the preferred range described above. In parts by weight, the mixing ratio between the resin component and the curing agent component is typically within a range from 1:2 to 20:1.

The components are mixed continuously or in batches by means of a suitable method, taking care to ensure that not too much time passes between the mixing of the components and the application, and that application takes place within the pot life. Mixing and application are preferably effected at ambient temperature, which is typically in the range from about 5 to 40° C., preferably about 10 to 35° C.

Upon mixing of the components, the curing of the epoxy resin composition by chemical reaction commences. Primary and secondary amino groups, and any further groups present that are reactive toward epoxy groups, react with the epoxy groups, resulting in ring opening thereof. As a result primarily of these reactions, the composition polymerizes and thereby cures.

Curing typically extends over a few hours to days. The duration depends on factors including the temperature, the reactivity of the constituents, the stoichiometry thereof, the polyphenol content, and the presence/amount of further accelerators.

In the freshly mixed state the epoxy resin composition has a low viscosity. The viscosity 5 minutes after the mixing of the components at 20° C. is preferably in the range from 0.1 to 20 Pa·s, preferably 0.2 to 10 Pa·s, more preferably 0.3 to 5 Pa·s, measured by cone-plate viscometer as described above.

The epoxy resin composition is applied to at least one substrate and/or to at least one casting mold.

Suitable substrates are especially:
glass, glass ceramic, concrete, mortar, cement screed, fiber cement, brick, tile, plaster or natural rocks such as granite or marble;
repair compounds or leveling compounds based on PCC (polymer-modified cement mortar) or ECC (epoxy resin-modified cement mortar);
metals or alloys such as aluminum, iron, steel, copper, other nonferrous metals, including surface-finished metals or alloys such as galvanized or chrome-plated metals;
asphalt or bitumen;
leather, textiles, paper, wood, wood-based materials bonded with resins, for example phenolic, melamine or epoxy resins, resin-textile composites or further what are referred to as polymer composites;
plastics, such as rigid and flexible PVC, polycarbonate, polystyrene, polyester, polyamide, PMMA, ABS, SAN, epoxy resins, phenolic resins, PUR, POM, TPO, PE, PP, EPM or EPDM, in each case untreated or surface-treated, for example by means of plasma, corona or flames;
fiber-reinforced plastics, such as carbon fiber-reinforced plastics (CFRP), glass fiber-reinforced plastics (GFRP), and sheet molding compounds (SMC);
insulation foams, especially made of EPS, XPS, PUR, PIR, rock wool, glass wool, aerogel or foamed glass;
coated or painted substrates, especially painted tiles, coated concrete, powder-coated metals or alloys or painted metal sheets;
coatings, paints or varnishes, especially coated floors that have been overcoated with a further floor covering layer.

The substrates can if required be pretreated prior to application, especially by physical and/or chemical cleaning methods or the application of an activator or a primer.

The substrates are especially coated and/or adhesively bonded.

A suitable casting mold is an apparatus into which the mixed, liquid epoxy resin composition is poured and in which it is cured, and from which it is or can be demolded after curing, where the cured composition forms a shaped body. The casting mold preferably consists at least of a material on the surface, from which the cured epoxy resin composition can be parted again without damage, especially made of metal, ceramic, plastic or silicone, optionally provided with a nonstick coating, especially of Teflon, silicone or a wax.

The invention further provides the cured composition obtained from the epoxy resin composition described after the components have been mixed.

The epoxy resin composition is preferably used as a coating, primer, adhesive, sealant, encapsulant, casting resin, impregnating resin, injection resin, anchor adhesive, adhesive mortar, or shaped body or matrix for composite materials.

The epoxy resin composition is more preferably used as coating, especially as floor coating, wall coating, component coating, pipe coating, tank interior coating, roof coating or protective coating, especially anticorrosion coating.

The solution of the invention enables epoxy resin products having particularly advantageous properties. Metered addition of the polyphenol is particularly easily possible without use of thinners or solvents, and particularly low-emission epoxy resin coatings are obtained with rapid curing, a particularly low tendency to surface faults caused by blushing, high final hardness, and surprisingly faultless curing under cold conditions. These advantageous properties are attained even with a low dosage of the solution of the invention, which means that the processibility of such coatings is very good even without thinner.

Particularly faultless curing under cold conditions is manifested in particular in the comparison of the König's hardness
a) after curing at 8° C./80% relative humidity over 7 days followed by further curing at 23° C./50% relative humidity for 14 days,
with the König's hardness
b) after curing at 23° C./50% relative humidity over 14 days,
in that the epoxy resin coating of the invention attains a König's hardness a) that corresponds virtually or completely to König's hardness b). In particular, the epoxy resin coating of the invention attains a value for König's hardness a) that corresponds to at least 70%, preferably at least 80%, more preferably at least 90%, of the value of König's hardness b).

This particularly faultless curing is achieved with the epoxy resin coating of the invention particularly even without or with only a small amount of thinners such as benzyl alcohol. Such an epoxy resin coating thus has particularly low emissions and is particularly robust in relation to the ambient conditions on processing and in relation to sustained stickiness in use.

### EXAMPLES

Working examples are adduced hereinafter, which are intended to further elucidate the invention described. It will be apparent that the invention is not limited to these described working examples.

“AHEW” stands for amine hydrogen equivalent weight.

“EEW” stands for epoxy equivalent weight.

“Standard climatic conditions” (“SCC”) refers to a temperature of 23±1° C. and a relative air humidity of 50±5%.

The chemicals used were from Sigma-Aldrich Chemie GmbH, unless otherwise stated.

### Substances and Abbreviations Used:

Araldite® GY 250: bisphenol A diglycidyl ether, EEW about 187 g/eq (Huntsman)
Araldite® DY-E: monoglycidyl ethers of C₁₂ to C₁₄ alcohols, EEW about 290 g/eq (Huntsman)
Araldite® DY-H: hexanediol diglycidyl ether, EEW about 147 g/eq (from Huntsman)
B-EDA: N-benzylethane-1,2-diamine, 150.2 g/mol, AHEW 50.1 g/eq, prepared as described hereinafter
B-EDA mix: reaction mixture containing N-benzylethane-1,2-diamine and N,N′-dibenzylethane-1,2-diamine in a weight ratio of 85/15, prepared as described hereinafter, AHEW 55 g/eq
F-EDA: N-furfurylethane-1,2-diamine, 140.1 g/mol, AHEW 46.7 g/eq, prepared as described hereinafter
B-PDA: N-benzylpropane-1,2-diamine, 164.4 g/mol, AHEW 54.8 g/eq, prepared as described hereinafter
DMAPAPA: 3-(3-dimethylaminopropylamino) propylamine, AHEW 53 g/eq (DMAPAPA, from Arkema)
IPDA 3-aminomethyl-3,5,5-trimethylcyclohexylamine, AHEW 42.6 g/eq (Vestamin® IPD, Evonik)
MXDA: 1,3-bis(aminomethyl)benzene, AHEW 34 g/eq (Mitsubishi Gas Chemical)
BAC 1,3-bis(aminomethyl)cyclohexane, AHEW 35.5 g/eq (from Mitsubishi Gas Chemical)
Phenolic resin PH-1 phenol-formaldehyde novolak, average molecular weight Mₙ about 430 g/mol, softening point 65 to 75° C. (Alnovol® PN 327/100, from Allnex)
Phenolic resin PH-2 phenol-formaldehyde novolak, average molecular weight Mₙ about 440 g/mol, softening point 65 to 75° C. (Supraplast®) 3616, from Süd-West-Chemie)
Phenolic resin PH-3 phenol-formaldehyde novolak, average molecular weight Mₙ about 950 g/mol, softening point 78 to 82° C. (Phenolite® TD-2131, from DIC)
Phenolic resin PH-4 phenol-formaldehyde novolak, average molecular weight Mₙ about 2,400 g/mol, softening point 108 to 120° C. (Alnovol® PN 320, from Allnex)
Phenolic resin PH-5 phenol-formaldehyde novolak, average molecular weight Mₙ about 2,600 g/mol, softening point 95 to 110° C. (FERS® FB8000SH, from Sumimoto Bakelite)
DPA diphenolic acid (4,4-bis(4-hydroxyphenyl) valeric acid)
K54 2,4,6-tris(dimethylaminomethyl) phenol (Ancamine® K54, from Evonik)

### Reaction Mixture Containing N-Benzylethane-1,2-Diamine (B-EDA Mix)

An initial charge of 180.3 g (3 mol) of ethane-1,2-diamine at room temperature was mixed with a solution of 106.0 g (1 mol) of benzaldehyde in 1,200 ml of isopropanol, and hydrogenated at 80° C., hydrogen pressure 80 bar and an H₂ flow rate of 5 ml/min in a continuous hydrogenation apparatus with a Pd/C fixed bed catalyst, and the hydrogenated solution was freed of the volatile constituents on a rotary evaporator at 65° C. This afforded a yellowish clear liquid having a content, determined by GC, of N-benzylethane-1,2-diamine of about 81% by weight and of N,N′-dibenzylethane-1,2-diamine of about 14% by weight, a content of ethane-1,2-diamine of 0.3% by weight and a calculated AHEW of 55 g/eq, which was used hereinafter as B-EDA mix.

### N-Benzylethane-1,2-diamine (B-EDA)

A portion of the reaction mixture containing N-benzylethane-1,2-diamine (B-EDA mix), prepared as described above, was purified at 80° C. by distillation under reduced pressure. This afforded a colorless liquid having an AHEW of 50.1 g/eq and a content, determined by GC, of N-benzylethane-1,2-diamine of >97%, which was used hereinafter as B-EDA.

### N-Furfurylethane-1,2-diamine (F-EDA)

An initial charge of 105.2 g (1.75 mol) of ethane-1,2-diamine at room temperature was mixed with a solution of 48.1 g (0.5 mol) of furfural in 1,200 ml of isopropanol, and hydrogenated at 80° C., hydrogen pressure 80 bar and an H₂ flow rate of 5 ml/min in a continuous hydrogenation apparatus with a Pd/C fixed bed catalyst, and the hydrogenated solution was freed of the volatile constituents on a rotary evaporator at 65° C. The resulting reaction mixture was purified by distillation at 70° C. under reduced pressure. This afforded a colorless liquid having an AHEW of 46.7 g/eq and a content, determined by GC, of N-furfurylethane-1,2-diamine of 94.6% by weight and of N-tetrahydrofurfurylethane-1,2-diamine of 5.3% by weight, which was used hereinafter as F-EDA.

### N-Benzylpropane-1,2-diamine (B-PDA)

An initial charge of 222.4 g (3 mol) of propane-1,2-diamine at room temperature was mixed with a solution of 106.0 g (1 mol) of benzaldehyde in 1,200 ml of isopropanol, and hydrogenated at 80° C., hydrogen pressure 80 bar and an H₂ flow rate of 5 ml/min in a continuous hydrogenation apparatus with a Pd/C fixed bed catalyst, and the hydrogenated solution was freed of the volatile constituents on a rotary evaporator at 65° C. The resulting reaction mixture was purified by distillation at 80° C. under reduced pressure. This afforded a colorless liquid having an AHEW of 54.8 g/eq and a content, determined by GC, of N-benzylpropane-1,2-diamine of >97% by weight and, by ¹H NMR, a ratio of N¹-benzylpropane-1,2-diamine and N²-benzylpropane-1,2-diamine of about 2/1, which was used hereinafter as B-PDA.

### Preparation of Solutions:

### Solutions L-1 to L-28:

According to tables 1 and 2, for each solution, an initial charge of the specified amine was heated up to 50 to 80° C., the specified polyphenol in the specified amount was dissolved in the amine while stirring, and the solution was cooled down to room temperature.

After a storage time of the solution of 24 hours at room temperature, the viscosity of the solution was measured on a thermostatted Rheotec RC30 cone-plate viscometer (cone diameter 50 mm, cone angle 1°, cone tip-plate distance 0.05 mm) at the specified temperature, using a shear rate of 100 s⁻¹ for viscosities of less than 100 mPa·s and a shear rate of 10 s⁻¹ for viscosities of 100 mPa·s or more.

The solutions labeled “(Ref.)” are noninventive comparative examples.

TABLE 1
Composition and viscosity of solutions L-1 to L-22.

| | | Phenolic | Weight | Viscosity | |
|---|---|---|---|---|---|
| | Amine | resin | ratio¹ | [mPa · s] | |
| Solution L-1 | B-EDA | PH-1 | 80/20 | 89 | (20° C.) |
| Solution L-2 | B-EDA | PH-1 | 70/30 | 525 | (20° C.) |
| Solution L-3 | B-EDA | PH-1 | 60/40 | 7,920 | (20° C.) |
| Solution L-4 | F-EDA | PH-1 | 80/20 | 68 | (20° C.) |
| Solution L-5 | F-EDA | PH-1 | 70/30 | 315 | (20° C.) |
| Solution L-6 | F-EDA | PH-1 | 60/40 | 3,710 | (20° C.) |
| Solution L-7 | B-PDA | PH-1 | 80/20 | 94 | (20° C.) |
| Solution L-8 (Ref.) | IPDA | PH-1 | 80/20 | 2,022 | (20° C.) |
| Solution L-9 (Ref.) | IPDA | PH-1 | 70/30 | 38,700 | (25° C.) |
| Solution L-10 | MXDA | PH-1 | 80/20 | 85 | (20° C.) |
| (Ref.) | | | | | |
| Solution L-11 | MXDA | PH-1 | 70/30 | 695 | (20° C.) |
| (Ref.) | | | | | |
| Solution L-12 | MXDA | PH-1 | 60/40 | 14,900 | (20° C.) |
| (Ref.) | | | | | |
| Solution L-13 | BAC | PH-1 | 80/20 | 153 | (20° C.) |
| (Ref.) | | | | | |
| Solution L-14 | BAC | PH-1 | 70/30 | 1,830 | (20° C.) |
| (Ref.) | | | | | |
| Solution L-15 | BAC | PH-1 | 60/40 | 28,900 | (25° C.) |
| (Ref.) | | | | | |
| Solution L-16 | TMD | PH-1 | 80/20 | 83 | (20° C.) |
| (Ref.) | | | | | |
| Solution L-17 | TMD | PH-1 | 70/30 | 565 | (20° C.) |
| (Ref.) | | | | | |
| Solution L-18 | TMD | PH-1 | 60/40 | 9,590 | (20° C.) |
| (Ref.) | | | | | |
| Solution L-19 | B-EDA | PH-2 | 80/20 | 78 | (20° C.) |
| Solution L-20 | B-EDA | PH-3 | 80/20 | 114 | (20° C.) |
| Solution L-21 | B-EDA | PH-4 | 80/20 | 186 | (20° C.) |
| Solution L-22 | B-EDA | PH-5 | 80/20 | 156 | (20° C.) |

¹weight ratio of amine/phenolic resin

TABLE 2
Composition and viscosity of solutions L-23 to L-28.

| | | | Weight | Viscosity | |
|---|---|---|---|---|---|
| | Amine | Polyphenol | ratio¹ | [mPa · s] | |
| Solution L-23 | B-EDA | DPA | 80/20 | 330 | (20° C.) |
| Solution L-24 | B-EDA | DPA | 70/30 | 8,860 | (20° C.) |
| Solution L-25 | B-EDA mix | DPA | 80/20 | 590 | (20° C.) |
| Solution L-26 | IPDA | DPA | 80/20 | too thick (paste) | |
| (Ref.) | | | | | |
| Solution L-27 | MXDA | DPA | 80/20 | 350 | (20° C.) |
| (Ref.) | | | | | |
| Solution L-28 | BAC | DPA | 80/20 | 960 | (20° C.) |
| (Ref.) | | | | | |

¹weight ratio of amine/polyphenol

Production of curing agents for epoxy resins:

### Curing Agents H-1 to H-19:

For each curing agent, the ingredients specified in table 3 in the specified amounts (in parts by weight) were mixed using a centrifugal mixer (SpeedMixer™ DAC 150, FlackTek Inc.) and stored with exclusion of moisture.

The viscosity of the curing agents was measured as described above.

The amine equivalent weight (AHEW) of the curing agents was calculated.

The results are reported in table 3.

Curing agents labeled “(Ref.)” are noninventive comparative examples.

TABLE 3
Composition (in % by weight) and properties of curing agents H-1 to H-19.

| | | Further | Viscosity | AHEW |
|---|---|---|---|---|
| | Solution | ingredients | [mPa · s] | [g/eq] |
| Curing agent H-1 (Ref.) | — | 100% B-EDA | 7 | 50.1 |
| Curing agent H-2 | 55.5% L-1 | 44.5% B-EDA | 26 | 56.4 |
| Curing agent H-3 | 100% L-1 | — | 89 | 62.6 |
| Curing agent H-4 | 55.5% L-19 | 44.5% B-EDA | 20 | 56.4 |
| Curing agent H-5 | 55.5% L-21 | 44.5% B-EDA | 25 | 56.4 |
| Curing agent H-6 | 55.5% L-22 | 44.5% B-EDA | 32 | 56.4 |
| Curing agent H-7 (Ref.) | — | 92.6% B-EDA | n.d. | 54.1 |
| | | 7.4% K54 | | |
| Curing agent H-8 (Ref.) | — | 100% F-EDA | 3 | 46.7 |
| Curing agent H-9 | 59.1% L-4 | 40.9% F-EDA | 21 | 53.0 |
| Curing agent H-10 | 51.2% L-7 | 48.8% B-PDA | 22 | 61.1 |
| Curing agent H-11 | 55.0% L-1 | 30.9% B-EDA | 20 | 56.9 |
| | | 14.1% DMAPAPA | | |
| Curing agent H-12 (Ref.) | 64.0% L-8 | 36.0% IPDA | 233 | 48.9 |
| Curing agent H-13 (Ref.) | 77.7% L-10 | 22.3% MXDA | 47 | 40.3 |
| Curing agent H-14 (Ref.) | 74.9% L-13 | 25.1% BAC | 79 | 41.8 |
| Curing agent H-15 (Ref.) | 68.2% L-16 | 31.8% TMD | 30 | 45.9 |
| Curing agent H-16 | 55.5% L-23 | 44.5% B-EDA | 48 | 56.4 |
| Curing agent H-17 | 51.1% L-25 | 48.9% B-EDA mix | 49 | 61.3 |
| Curing agent H-18 (Ref.) | 77.7% L-27 | 22.3% MXDA | 111 | 40.3 |
| Curing agent H-19 (Ref.) | 74.9% L-28 | 25.1% BAC | 230 | 41.8 |

“n.d.” stands for “not determined”

### Production of Epoxy Resin Compositions:

### Compositions Z-1 to Z-19:

For each composition, the ingredients of the resin component reported in tables 4 to 7 were mixed in the specified amounts (in parts by weight) using a centrifugal mixer (SpeedMixer™ DAC 150, FlackTek Inc.) and stored with exclusion of moisture.

Subsequently, the curing agents specified in tables 4 to 7, in the specified amounts (in parts by weight), were mixed with the resin component using the centrifugal mixer, and the mixed composition was immediately tested as follows:

Viscosity (5′) was measured as described above at a temperature of 20° C. 5 min after the resin component and the curing agent component had been mixed.

Gel time was determined by moving a freshly mixed amount of about 3 g under standard climatic conditions with a spatula at regular intervals until the mass underwent gelation.

Shore D hardness was determined in accordance with DIN 53505 on two cylindrical test specimens (diameter 20 mm, thickness 5 mm), one of which was stored under standard climatic conditions and the other at 8° C. and 80% relative humidity, and the hardness measured in each case after 1 day (24 h) and after 2 days.

In addition, a film was applied to a glass plate in a layer thickness of 500 μm, and this was stored/cured under standard climatic conditions. König's hardness (König's pendulum hardness to DIN EN ISO 1522) was determined on this film after 1 day, 2 days, 7 days and 14 days (1d SCC), (2d SCC), (7d SCC), (14d SCC). After 14 days, the appearance (SCC) of the film was assessed. A clear film was described as “attractive” if it had a glossy and nonsticky surface with no structure. “Structure” referred to any kind of marking or pattern on the surface.

A further film was applied to a glass plate in a layer thickness of 500 μm and, immediately after application, stored/cured at 8° C. and 80% relative humidity for 7 days and then under standard climatic conditions for 2 weeks. 24 hours after application, a polypropylene bottletop beneath which a moist sponge had been positioned was placed on the film. After a further 24 hours, the sponge and the bottletop were removed and positioned at a new point on the film, from which they were in turn removed and repositioned after 24 hours, which was done 4 times in total. The appearance of this film was then assessed (designated “Appearance (8°/80%)” in the tables) in the same way as described for Appearance (SCC). Also reported in each case here was the number and nature of visible marks that had formed in the film as a result of the damp sponge or the bottletop on top. The number of white discolored spots was reported as “blushing”. “(1)” denoted one faint white discolored spot. “1” denoted one clear white discolored spot. “Ring” was used to state how many ring-shaped impressions were present as a result of indentation of the bottletop placed on. “(1)” denoted a faint impression of the bottletop, “1” a clear impression. (A ring-shaped impression indicates that the coating was not yet ready to be walked on.) König's hardness was again determined on the films thus cured, in each case after 7 days at 8° C. and 80% relative humidity (König's hardness (7d 8°/80%)) and then after a further 2 days under SCC (König's hardness (+2d SCC)), 7 days under SCC (König's hardness (+7d SCC)), and 14 days under SCC (König's hardness (+14d SCC)). As a measure of yellowing, the change in color after stressing in a weathering tester was also determined. For this purpose, a further film was applied to a glass plate in a layer thickness of 500 μm and this was stored/cured under standard climatic conditions for 2 weeks and then stressed for 72 hours at a temperature of 65° C. in a Q-Sun Xenon Xe-1 weathering tester having a Q-SUN Daylight-Q optical filter and a xenon lamp having a light intensity of 0.51 W/m² at 340 nm (Q-Sun (72 h)). The color difference ΔE of the stressed film versus the corresponding unstressed film was then determined using an NH310 colorimeter from Shenzen 3NH Technology Co. LTD equipped with silicon photoelectric diode detector, light source A, color space measurement interface CIE L*a*b*C*H*. ΔE values up to 5 represent slight yellowing.

The results are given in tables 4 to 7.

The compositions labeled “(Ref.)” are noninventive comparative examples.

TABLE 4
Composition and properties of Z-1 to Z-7.

| | Composition | | | | | | |
|---|---|---|---|---|---|---|---|
| | Z-1 | | | | | | Z-7 |
| Resin component: | (Ref.) | Z-2 | Z-3 | Z-4 | Z-5 | Z-6 | (Ref.) |
| Araldite ® GY-250 | 167.2 | 167.2 | 167.2 | 167.2 | 167.2 | 167.2 | 167.2 |
| Araldite ® DY-E | 31.8 | 31.8 | 31.8 | 31.8 | 31.8 | 31.8 | 31.8 |

| | | H-1 | H-2 | H-3 | H-4 | H-5 | H-6 | H-7 |
|---|---|---|---|---|---|---|---|---|
| Curing agent: | | 50.1 | 56.4 | 62.6 | 56.4 | 56.4 | 56.4 | 54.1 |
| Viscosity (5′) [mPa · s] | | 190 | 390 | 740 | 460 | 590 | 510 | 230 |
| Gel time (h:min) | | 5:20 | 3:15 | 2:30 | 2:55 | 3:00 | 2:50 | 4:30 |
| Shore D | (1 d SCC) | 61 | 79 | 75 | 68 | 73 | 71 | 74 |
| | (2 d SCC) | 62 | 81 | 77 | 78 | 75 | 77 | 75 |
| Shore D | (1 d 8°/80%) | n.m.¹ | 70 | 73 | 66 | 62 | 65 | 19 |
| | (2 d 8°/80%) | 72 | 73 | 75 | 73 | 70 | 74 | 76 |
| König's hardness(1 d S [symbol] | | 56 | 129 | 139 | 102 | 120 | 109 | 106 |
| [s] | (2 d SCC) | 72 | 162 | 161 | 137 | 158 | 129 | 149 |
| | (7 d SCC) | 136 | 181 | 182 | 182 | 181 | 179 | 184 |
| | (14 d SCC) | 151 | 200 | 198 | 200 | 201 | 200 | 201 |
| Appearance (SCC) | | attractive | attractive | attractive | attractive | attractive | attractive | attractive |
| Q-Sun (72 h) ΔE | | 4.2 | 8.6 | 10.7 | 8.5 | 11.7 | 7.0 | 12.3 |
| König's hardness (7 d 8 [symbol] | | 21 | 56 | 71 | 35 | 49 | 42 | 49 |
| [s] | (+2 d SCC) | 55 | 130 | 161 | 69 | 134 | 120 | 106 |
| | (+7 d SCC) | 85 | 176 | 176 | 154 | 171 | 150 | 136 |
| | (+14 d SCC) | 112 | 182 | 184 | 168 | 175 | 169 | 148 |

| | | | | | | | |
|---|---|---|---|---|---|---|---|
| Appearance (8°/80%) | attractive | attractive | attractive | attractive | attractive | attractive | attractive |
| Blushing | none | none | none | none | none | none | 1 |
| Ring | none | none | none | none | none | none | none |
| KH (cold)/KH (SCC) ² | 74% | 91% | 93% | 84% | 87% | 85% | 74% |

¹not measurable (too soft)
² König's hardness (7 d 8°/80% + 14 d SCC) relative to Konig's hardness (14 d SCC) in percent [symbol]
indicates data missing or illegible when filed

TABLE 5
Composition and properties of Z-8 to Z-11.

Composition

| | Z-8 | | | |
|---|---|---|---|---|
| Resin component: | (Ref.) | Z-9 | Z-10 | Z-11 |
| Araldite ® GY-250 | 167.2 | 167.2 | 167.2 | 167.2 |
| Araldite ® DY-E | 31.8 | 31.8 | 31.8 | 31.8 |

| | | H-8 | H-9 | H-10 | H-11 |
|---|---|---|---|---|---|
| Curing agent: | | 46.7 | 53.0 | 61.1 | 56.9 |
| König's hardness(1 d S [symbol] | | 38 | 105 | 115 | 101 |
| [s] | (2 d SCC) | 57 | 129 | 171 | 113 |
| | (7 d SCC) | 118 | 162 | 203 | 186 |
| | (14 d SCC) | 119 | 182 | 205 | 201 |
| Appearance (SCC) | | attractive | attractive | attractive | attractive |
| Q-Sun (72 h) ΔE | | 12.9 | 29.0 | 3.9 | 17.2 |
| König's hardness (7 d 8 [symbol] | | 11 | 27 | 66 | 60 |
| [s] | (+2 d SCC) | 36 | 64 | 175 | 115 |
| | (+7 d SCC) | 52 | 137 | 201 | 157 |
| | (+14 d SCC) | 81 | 154 | 201 | 174 |

| | | | | |
|---|---|---|---|---|
| Appearance (8°/80%) | attractive | attractive | attractive | attractive |
| Blushing | 1 | (1) | none | (1) |
| Ring | 1 | none | (1) | none |
| KH (cold)/KH (SCC) ¹ | 68% | 85% | 98% | 87% |

¹ König's hardness (7 d 8°/80% + 14 d SCC) relative to König's hardness (14 d SCC) in percent [symbol]
indicates data missing or illegible when filed

TABLE 6
Composition and properties of Z-12 to Z-15.

Composition

| | Z-12 | Z-13 | Z-14 | Z-15 |
|---|---|---|---|---|
| Resin component: | (Ref.) | (Ref.) | (Ref.) | (Ref.) |
| Araldite ® GY-250 | 167.2 | 167.2 | 167.2 | 167.2 |
| Araldite ® DY-E | 31.8 | 31.8 | 31.8 | 31.8 |

| | | H-12 | H-13 | H-14 | H-15 |
|---|---|---|---|---|---|
| Curing agent: | | 48.9 | 40.3 | 41.8 | 45.9 |
| Viscosity (5′) [mPa · s] | | 1,240 | 760 | 890 | 620 |
| Gel time (h:min) | | 2:45 | 2:15 | 1:35 | 2:20 |
| Shore D | (1 d SCC) | 65 | 75 | 76 | 76 |
| | (2 d SCC) | 72 | 79 | 81 | 83 |
| Shore D | (1 d 8°/80%) | 45 | 78 | 73 | 34 |
| | (2 d 8°/80%) | 54 | 81 | 77 | 72 |
| König's hardness(1 d S [symbol] | | 132 | 73 | 113 | 63 |
| [s] | (2 d SCC) | 158 | 94 | 87 | 99 |
| | (7 d SCC) | 195 | 101 | 95 | 129 |
| | (14 d SCC) | 201 | 125 | 105 | 197 |
| Appearance (SCC) | | structure | structure | structure | structure |
| Q-Sun (72 h) ΔE | | 7.9 | 11.4 | 14.0 | 16.1 |
| König's hardness (7 d 8 [symbol] | | 67 | 18 | 35 | 11 |
| [s] | (+2 d SCC) | 70 | 34 | 36 | 14 |
| | (+7 d SCC) | 137 | 43 | 38 | 29 |
| | (+14 d SCC) | 141 | 63 | 42 | 43 |

| | | | | |
|---|---|---|---|---|
| Appearance (8°/80%) | hazy | hazy | structure | hazy |
| Blushing | 4 | 3 | 2 | 3 |
| Ring | none | none | none | none |
| KH (cold)/KH (SCC) ¹ | 70% | 50% | 40% | 22% |

¹ König's hardness (7 d 8°/80% + 14 d SCC) relative to König's hardness (14 d SCC) in percent [symbol]
indicates data missing or illegible when filed

TABLE 7
Composition and properties of Z-16 to Z-19.

Composition

| | | | Z-18 | Z-19 |
|---|---|---|---|---|
| Resin component: | Z-16 | Z-17 | (Ref.) | (Ref.) |
| Araldite ® GY-250 | 167.2 | 167.2 | 167.2 | 167.2 |
| Araldite ® DY-E | 31.8 | 31.8 | 31.8 | 31.8 |

| | | H-16 | H-17 | H-18 | H-19 |
|---|---|---|---|---|---|
| Curing agent: | | 56.4 | 61.3 | 40.3 | 41.8 |
| Viscosity (5′) [mPa · s] | | 520 | 510 | n.m.¹ | n.m.¹ |
| Gel time (h:min) | | 3:20 | 3:25 | n.m.¹ | n.m.¹ |
| Shore D | (1 d SCC) | 79 | 78 | n.m.¹ | n.m.¹ |
| | (2 d SCC) | 80 | 80 | | |
| Shore D | (1 d 8°/80) | 61 | 62 | n.m.¹ | n.m.¹ |
| | (2 d 8°/80) | 63 | 74 | | |
| König's hardness(1 d S [symbol] | | 129 | 99 | n.m.¹ | n.m.¹ |
| [s] | (2 d SCC) | 167 | 168 | | |
| | (7 d SCC) | 200 | 185 | | |
| | (14 d SCC) | 202 | 195 | | |
| Appearance (SCC) | | attractive | attractive | n.m.¹ | n.m.¹ |
| König's hardness (7 d 8 [symbol] | | 57 | 56 | n.m.¹ | n.m.¹ |
| [s] | (+2 d SCC) | 126 | 143 | | |
| | (+7 d SCC) | 181 | 185 | | |
| | (+14 d SCC) | 185 | 192 | | |

| | | | | |
|---|---|---|---|---|
| Appearance (8°/80%) | attractive | attractive | n.m.¹ | n.m.¹ |
| Blushing | (1) | (1) | | |
| Ring | none | none | | |
| KH (cold)/KH (SCC) ² | 91% | 98% | n.m.¹ | n.m.¹ |

¹not measurable: inhomogeneous on mixing owing to incompatibility of the curing agent with the resin component
² König's hardness (7 d 8°/80% + 14 d SCC) relative to König's hardness (14 d SCC) in percent [symbol]
indicates data missing or illegible when filed

### Use of a Polyphenol Solution as a Separate Component:

### Compositions Z-20 to Z-22:

For these compositions, the resin component specified in table 8 in the specified amount (in parts by weight) was used as the first component.

In addition, the curing agent component specified in table 8 in the specified amounts (in parts by weight) was used as the second component.

A further third component used was the solution specified in table 8 in the specified amounts (in parts by weight).

The components of each composition were processed using a centrifugal mixer to give a homogeneous liquid, and this was tested immediately as follows:

Viscosity, gel time and Shore D were tested as described for composition Z-1. Moreover, a film was applied to a glass plate in a layer thickness of 500 μm and stored at 8° C. and 80% relative humidity for 7 days. 24 hours after application, a polypropylene bottletop was placed onto the film, beneath which a moist sponge had been positioned. After a further 24 hours, the sponge and the bottletop were removed and positioned at a new point on the film, from which they were in turn removed and repositioned after 24 hours, which was done 4 times in total. Subsequently, the appearance of the film was assessed as described for composition Z-1 Appearance (8°/80%).

The results are reported in table 8.

The composition labeled “(Ref.)” is a comparative example.

TABLE 8
Composition and properties of Z-20 to Z-22.

| | | Composition | | |
|---|---|---|---|---|
| | | Z-20 | | |
| | | (Ref.) | Z-21 | Z-22 |
| Resin component (first comp.): | | | | |
| Sikafloor ®-264N (A) (RAL 5005) ¹ | | 436.0 | 436.0 | 436.0 |
| Curing agent component | | | | |
| (second comp.): | | | | |
| Sikafloor ®-264N (B) ² | | 120.0 | 108.0 | 96.0 |
| Solution L-3 (third component) | | — | 8.2 | 16.4 |
| Viscosity (5′) [Pa · s] | | 2.5 | 3.2 | 4.9 |
| Gel time (h:min) | | 2:55 | 2:25 | 2:05 |
| Shore D | (1 d SCC) | 45 | 51 | 58 |
| | (2 d SCC) | 60 | 67 | 69 |
| Shore D | (1 d 8°/80%) | 33 | 41 | 53 |
| | (2 d 8°/80%) | 57 | 65 | 67 |

| | | | |
|---|---|---|---|
| Appearance (8°/80%) | attractive | attractive | attractive |
| Blushing | 2 | 1 | 1 |
| Ring | none | none | none |

¹ filled pigmented resin component with an epoxy resin floor coating, EEW 436 g/eq (from Sika)
² formulated unfilled curing agent for epoxy resins, AHEW 120 g/eq (from Sika)

1. A solution comprising 5% to 65% by weight of room temperature solid polyphenols and 35% to 95% by weight of amines of the formula (I) 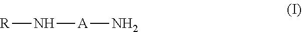
where
A is a linear or branched alkylene radical having 2 to 10 carbon atoms and
R is a monovalent hydrocarbon radical optionally containing an oxygen atom and having 1 to 12 carbon atoms,
where the amine of the formula (I) has a total of 8 to 15 carbon atoms and the two nitrogen atoms are separated from one another by at least two carbon atoms.

2. The solution as claimed in claim 1, wherein the room temperature solid polyphenol is selected from the group consisting of gallic acid, diphenolic acid, resveratrol, catechin and polymers containing phenol groups.

3. The solution as claimed in claim 1, wherein the room temperature solid polyphenol is a phenolic resin of the formula (II) 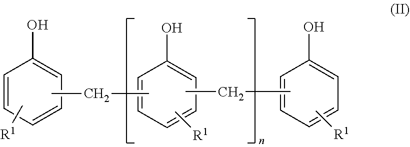
where
n has an average value of 1 to 45, and
R¹ is independently H or an aliphatic hydrocarbon radical having 1 to 15 carbon atoms.

4. The solution as claimed in claim 1, wherein A is selected from 1,2-ethylene, 1,2-propylene, 1,3-propylene, 1,4-butylene, 1,3-butylene, 2-methyl-1,2-propylene, 1,3-pentylene, 1,5-pentylene, 2,2-dimethyl-1,3-propylene, 1,6-hexylene, 2-methyl-1,5-pentylene, 1,7-heptylene, 1,8-octylene, 2,5-dimethyl-1,6-hexylene, 1,9-nonylene and 1,10-decylene.

5. The solution as claimed in claim 1, wherein R contains at least one aromatic or aliphatic ring and is selected from benzyl, furfuryl, 2-phenylethyl, cyclohexylmethyl and tetrahydrofurfuryl.

6. The solution as claimed in claim 1, wherein it includes
5% to 65% by weight of room temperature solid polyphenols,
35% to 95% by weight of amines of the formula (I), and
0% to 30% by weight of further amines that do not conform to the formula (I) and/or thinners and/or further accelerators.

7. The solution as claimed in claim 6, wherein it additionally includes
at least one amine of the formula (Ia) and/or one amine of the formula (Ib) 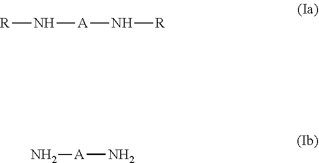
where A and R are each the same radical as in the corresponding amine of the formula (I),
and/or amine-functional adducts of the amine of the formula (I) with at least one mono- or polyepoxide.

8. The solution as claimed in claim 1, wherein the viscosity at 20° C. measured by cone-plate viscometer is in the range from 0.01 to 100 Pa·s.

9. A curing agent for epoxy resins, comprising the solution as claimed in claim 1 and at least one further amine having at least three amine hydrogens.

10. The curing agent as claimed in claim 9, wherein the further amine having at least three amine hydrogens is selected from the group consisting of amines of the formula (I), 1,5-diamino-2-methylpentane, 2-butyl-2-ethylpentane-1,5-diamine, 2,2 (4),4-trimethylhexane-1,6-diamine, 1,2-diaminocyclohexane, 1,3-bis(aminomethyl)cyclohexane, 1,4-bis(aminomethyl)cyclohexane, bis(4-aminocyclohexyl) methane, isophoronediamine, 2 (4)-methyl-1,3-diaminocyclohexane, 2,5 (2,6)-bis(aminomethyl) bicyclo[2.2.1]heptane, 1,3-bis(aminomethyl)benzene, diethylenetriamine, triethylenetetramine, tetraethylenepentamine, dipropylenetriamine, N-(2-aminoethyl) propane-1,3-diamine, N,N′-bis(3-aminopropyl)ethylenediamine, bis(hexamethylene)triamine, polyoxypropylenediamines having an average molecular weight Mₙ in the range from 200 to 500 g/mol, polyoxypropylenetriamines having an average molecular weight Mₙ in the range from 300 to 500 g/mol, 3-(3-(dimethylamino) propylamino) propylamine, 2,5-bis(aminomethyl) furan, 2,5-bis(aminomethyl)tetrahydrofuran, bis(5-aminomethylfuran-2-yl) methane, bis(5-aminomethyltetrahydrofuran-2-yl) methane, 2,2-bis(5-aminomethylfuran-2-yl) propane, 2,2-bis(5-aminomethyltetrahydrofuran-2-yl) propane, amine-functional adducts of the amines mentioned with mono- or polyepoxides, phenalkamines and mixtures of two or more of the amines mentioned.

11. The curing agent as claimed in claim 9, wherein the curing agent contains 2% to 30% by weight of room temperature solid polyphenols based on the sum total of all liquid or dissolved constituents present in the curing agent.

12. The curing agent as claimed in claim 9, wherein the curing agent, based on the sum total of all liquid or dissolved constituents present in the curing agent, has an amine hydrogen equivalent weight of 50 to 140 g/eq.

13. The curing agent as claimed in claim 9, wherein the curing agent, based on the sum total of all liquid or dissolved constituents present in the curing agent, has a viscosity at 20° C. measured by cone-plate viscometer is in the range from 10 to 5,000 mPa·s.

14. An epoxy resin composition comprising a resin component containing at least one epoxy resin and either
a curing agent component comprising the curing agent as described in claim 9
or
a curing agent component comprising at least one amine having at least three amine hydrogens and, as a separate, third component, the solution comprising 5% to 65% by weight of room temperature solid polyphenols and 35% to 95% by weight of amines of formula (I).

15. A cured epoxy resin composition obtained from the epoxy resin composition as claimed in claim 14 after mixing the components.
